(19) United States
(12) Patent Application Publication
(10) Pub. No.: US 2012/0036982 A1
(43) Pub. Date: Feb. 16, 2012

(54) Digital and Analog Output Systems for Stringed Instruments

(76) Inventor: Daniel Sullivan, Shoreview, MN (US)

(21) Appl. No.: 13/161,255

(22) Filed: Jun. 15, 2011

Related U.S. Application Data
(60) Provisional application No. 61/354,710, filed on Jun. 15, 2010.

(51) Int. Cl. G10H 3/06

(52) U.S. Cl. 84/724

(57) ABSTRACT

Systems are shown herein for use in stringed musical instruments for producing digital frequency and volume data. A finger contact sensor system detects the location of one or more fingers or objects at selected locations on a finger board of the instrument. Further string movement sensor systems determine if one or more strings are being played. A control system processes information from the finger contacting and string movement sensor systems to generate a digital signal containing the frequency data corresponding to the finger contacting point on the finger board and volume data corresponding to the sensed movement of a corresponding string.

### BACKGROUND OF THE INVENTION

It is well understood that digital technology has made a large impact in the music industry. For example, electronic keyboards are now capable of playing an almost infinite variety digitally sampled and stored sounds as well as create new sounds. MIDI (Musical Instrument Digital Interface) is the digital format that has provided vast new opportunities and abilities for musicians in the composing and playing of music by connecting keyboards, computers, sound controllers and the like.

The piano keyboard was ideally suited for conversion to playing digitally produced sounds as the individual keys could be changed from operating a mechanical action that caused a hammer to strike a piano wire, to essentially operating a switch. The switch would then signal which sound is to be sent to an amplifier and expressed audibly through a loud speaker and/or to a recording device and recorded. Over time, it was also possible with weighted actions, force sensing and the like for an electronic piano to provide the equivalent feel and play sensation as that of an actual acoustic piano.

The same opportunity for digital conversion was not as readily available for other stringed instruments where the strings are played directly by the musician, such as with guitars, mandolins, harps, violins, cello's and the like. Prior art attempts at such conversion focused on having an analog sensor, or “pick-up” as is found in electric guitars. The analog frequency output from the pickup would be sensed and subsequently converted to a digital signal that could be output to a sound generator and ultimately amplified and played through a speaker. The problem encountered early on with the technique of generating digital data from the vibration of one or more strings of the instrument was latency. There would always be an inherent and noticeable lag of time, especially obvious to the musician, between when they caused a string to vibrate through, strumming, picking, bowing or the like and when an appropriate sound would be heard. And, the problem only gets worse with lower frequencies as the corresponding periods become longer. The fact that the amount of latency also varies considerably across the note spectrum of the stringed instrument is another aspect of this problem that requires adaptation on the part of the player.

A MIDI system for defining a note event exists and includes a frequency parameter and a velocity or volume parameter. In an electronic keyboard the playing of a particular key automatically determines the frequency parameter and the speed and force with which it is struck is then correlated to volume. In existing digital stringed instrument methods, such as those described above, there are additional problems in accurately determining the volume of the note. There is again a finite time that must elapse before this determination can be made, which can cause additional delays on top of the frequency determination. Since both the frequency and the volume information have to be released together to form a MIDI code, the delay becomes equal to the slowest of the two.

Both the volume and frequency determination of a note are also prone to many errors, because there are many overtones in a signal that combine to make this process difficult. For example, a standard guitar pickup may have an inherent sixty cycle AC current induced “hum”, or sympathetic harmonic vibrations with other strings may exist that can create frequencies that may falsely trigger the playing of unwanted notes.

Another problem with existing digital stringed instruments is capturing certain expression nuances. For example, an important element of playing a guitar and other stringed instruments is note bending, or changing the pitch of a note by stretching the string after it is initially played. Since the pitch of the note is constantly changing during such bending, the problem of converting this in real time to a digital signal becomes impractical. Other expression nuances include hammer-ons, pull-offs, and producing vibrato, and are equally difficult to sense and reproduce digitally.

In order to accomplish the goal of a digital interface without latency, some systems have used the fret board of a guitar as a switch matrix input, similar to a keyboard wherein a series of push-button switches are installed on the fingerboard. This approach does not use guitar strings and requires a substantial adaptation of playing style, without allowing for the capture of expression nuances. Another technique that has been used takes advantage of the fact metal guitar strings are electrically conductive, as are the fret bars located on the guitar neck. As the strings are fretted by the player, an electrical contact is made and can be read. It is necessary in this case to produce special fret bars that are separated into six segments in order to distinguish a unique contact when all strings are fretted across and a common bus is formed. This method is expensive to manufacture, difficult to play and is also incapable of capturing expression nuances.

Music based video games, as for example “Guitar Hero®” sold by Activision Publishing, Inc. or “Rock Band®” as sold by Harmonix Music Systems, Inc., are will known in the art. These video games include a scrolling track shown on a video display which indicates to the player when to push one or any of five buttons on a game controller. The game controller is generally designed to simulate the look and feel of a guitar. Operating the buttons provides a very general simulation of contacting the strings of an actual guitar to play notes. The player is also required to, simultaneously with the pushing of one or more of the buttons, move a two position strum switch used to simulate strumming or playing the strings of a guitar. It would be desirable for many persons involved in music game play to be able to use a real guitar when playing a music based video game.

Commercial programs are available for personal computers that can alter the sound of a guitar that is connected to a computer loaded with such software. Connection hardware is also widely available that converts the analog guitar signal into a digital form that can then be processed by this computer software. These programs enable the user to select from a wide variety of guitar effects, and can emulate, for example, the sound of different guitar amplifier combinations. With the graphical user interface that is provided with the software, a musician can, prior to a performance, select and manipulate a variety of controls, such as with a mouse or touch screen, and select the various sound parameters that the software permits. Of course, these software programs and hardware devices are very useful to a musician prior to a performance, however controlling the various parameters is not practical for them during a performance.

### SUMMARY OF THE INVENTION

The present invention is described herein in its various embodiments and provides for digital output from stringed instruments that is not subject to the latency inadequacies seen in the prior art. The present invention also provides for digital output from stringed instruments that does not require any adaptation on the part of musician in terms of altering their style of playing, that faithfully captures expression nuances and that provides for the foregoing advantages in a cost effective manner.

In one embodiment the present invention includes a sensor system for sensing a string or strings being pressed against the exterior playing surface of a finger board or fret board of a stringed instrument. As is well understood, changes in the operating length of a string and hence its vibrational frequency are accomplished by the musician pressing the string or strings against a hard exterior playing surface of a finger board or fret board at various positions along the length thereof. This has the effect of shortening or lengthening the effective vibrating length of the string or strings and thereby producing the higher and lower tones respectively. Of course, each string can be played in its open position representative of the lowest note produced thereby. The instant embodiment includes a sensor system located along and below the exterior string contacting playing surface of the fingerboard or fret board. The system includes a plurality of light emitters paired with a corresponding plurality of photo sensors along and below the playing surface and arranged to sense finger contact at the points there along corresponding to the optimal string tone, i.e. at each of the desired half-step notes of the standard twelve note chromatic scale. A finger sensing event occurs when the musician places their finger against a string and against the playing surface When the musician's finger or fingers contacts and presses a string or strings against and at various desired positions along the playing surface, the finger or fingers along with the string or strings provide a light reflecting combination where light from an emitter is reflected there from to the corresponding light sensor triggering a sensing event.

It is understood by those of skill that the distance between half step note differences decreases along any one string as the note tone increases, i.e. gets higher. This physics of string vibration is visibly apparent on fretted stringed instruments where it can be seen that the frets associated with the lower notes are spread out more widely, there is a greater distance between them, than as is seen with the frets associated with the higher notes. The present invention can accommodate this fact by positioning more than one photo sensor per note/fret position along a string to provide for sensing over the greater surface area presented between the lower half note fretted positions.

Those of skill will further understand that the placement and number of photo emitters and photo sensors is not dependent upon their being an actual visible fret bar, as with a guitar, but can work equally well with a non-fretted stringed instrument, such as a violin. Those of skill will also appreciate that the photo sensors can be set at varying thresholds of light sensitivity for adjusting what will qualify as a note playing event occurring. Thus, the number and positioning of the photo emitters and sensors, along with the setting of the sensitivity of the photo sensors can provide for varying the accuracy with which a note playing event is judged to have occurred. The invention herein can therefore be set to, for example, require very precise finger placements to maintain the skills of an advanced musician or to enhance the skills of one seeking to improve. On the other hand, for a beginner the invention herein can be set up to be more “forgiving” and signal a correct finger placement occurring over a wider surface area than for a novice or advanced player. Thus, although a finger placement would result in a note that would otherwise be too sharp or too flat, that finger placement in the novice or beginner mode will nevertheless signal the correct note frequency to be played.

In stringed instruments such as guitars having a relatively flat fret board playing surface the playing of chords is accomplished by a particular fingering where multiple strings are fretted at the same time with all or most of the strings being strummed. The present invention provides for the ability to play chords by sensing the pattern of the finger placements and signaling the playing of the notes corresponding to that chord

With respect to the playing of chords the present invention has the same ability to vary the accuracy with respect to the required finger placement as described above. Thus, if a chord is desired to be played on a guitar the accuracy of the finger placements that produce the desired chord can be adjusted between an expert and beginner level. Moreover, it is also possible for the invention herein to fill in notes of the chord that are missing or to play the correct note where an incorrect finger placement is sensed.

In addition to sensing the position along the string at which the player is contacting the playing surface to play a particular note, the invention herein also provides systems for determining that the string has been played as through picking, strumming or the like. Those of skill will understand that an assumption could be made that if a string contact event has been sensed, that a string playing event is also intended and a predetermined volume parameter could be used. This approach is seen in an embodiment of the present invention that provides for essentially “one-handed” playing where the strings are “played” by simply pushing them against the playing surface and initiating both a frequency and pre-selected volume parameter at the same time. Of course, this approach has its limitations as the pressing of a string against the playing surface may not indicate the desire to play that note at that time. For example, a guitarist may be holding down the notes of a particular chord but rather than strumming all the strings may use a pick to play certain of the strings individually. Also, having a constant volume would completely remove from the musician one of their most important performance parameters.

An embodiment of the present invention describes an alternative system for determining when a string has been played. In this embodiment standard electric pickups of the magnetic or piezoelectric type as used in electric guitars and electric violins are utilized. The analog output of a standard pickup is then sensed and used to indicate that a string has been played and the volume thereof.

The present invention also includes an actual guitar that has been designed to function as a controller for use with electronic music video games. As the present invention includes sensors beneath the playing surface of a stringed musical instrument, five consecutive note or fret positions thereof can be adapted and used when in a game controller mode and used to provide controller signals for the five positions used by the noted music based video games. Moreover, the two position strum switch can be replaced by the string vibration detection technology as also described herein. Such a guitar can be further adapted to connect signals from the touch sensors and the strum detection sensors to a system for electronically communicating such signals wirelessly with a game console or computer. Thus, the present invention permits an actual guitar to act as a game controller and thereby provide a heightened degree of reality for the player. The digital signal output of the present invention may be configured to be used by other video games or computing system having an entertainment or learning application.

The electronic guitar of the invention herein produces finger placement or touch signals that can also be sent wirelessly to provide for control over external software programs and hardware that are used to change the sound produced by the guitar. Various other switches found on a typical electric guitar can also be adapted to produce signals that can be sent wirelessly to control such external sound altering software programs. The invention herein can further adapt a simulated tremolo or “whammy” bar as found on music video game controllers to an actual guitar. The touch sensors, switches and simulated tremolo bar can all be used as controls for the operation of external sound altering software. As all of these switches are convenient for a guitarist to use as they are easily manipulated during a performance and as guitarists are completely familiar with the use and feel thereof, the invention herein provides a way for a person playing a stringed instrument to easily access a wide variety of digital sounds and effects during a performance.

These sound altering software and hardware systems can also provide for the same sound alteration as is provided by the well known foot pedals used by guitarists for decades to impart distortion, reverb, “wha-wha” effects and the like. Thus the invention herein can reduce the need for foot pedals wherein various of the touch photo sensors, switches or simulated tremolo bar can be used to select the various sound effects produced thereby. Having the controls accessible on the body of the guitar enabled the guitar player to easily and interactively control such parameters during the course of playing the guitar.

### BRIEF DESCRIPTION OF THE FIGURES

A better understanding of the structure, function, operation and the objects and advantages of the present invention can be had by reference to the following detailed description which refers to the following figures, wherein:

FIG. 1 shows a stringed musical instrument according to one embodiment of the present invention.

FIG. 2 shows a cross-sectional view of the along lines 2-2 of the neck of the instrument of FIG. 1.

FIG. 3 shows an enlarged view pursuant to FIG. 2.

FIG. 4 shows a top plan schematic view of a finger contact sensor system according to one embodiment.

FIG. 5 shows a top plan schematic view of a finger contact sensor system according to a further embodiment.

FIG. 6 shows a cross-sectional view of an embodiment of a finger contact sensing system in a neck of a stringed instrument.

FIG. 7 shows a block diagram of certain of the electronics of an embodiment of the invention herein.

FIG. 8 shows a reverse plan view of the instrument of FIG. 1.

FIG. 9 shows a block diagram of certain electronic components according to one embodiment of the invention herein.

FIG. 10 shows a side plan view of a string motion sensor embodiment of the invention herein.

FIG. 11 shows a further side plan view of the string motion sensor embodiment of FIG. 10.

FIG. 12 shows a side plan view of a further string motion sensor embodiment.

FIG. 13 shows a graph of a signal output of the photosensors of the embodiment of FIG. 12.

FIG. 14 shows a string bending detection system embodiment.

FIG. 15 shows a further embodiment of an electronic guitar of the present invention.

FIG. 16 shows a schematic representation of the finger placements of various guitar chords.

FIG. 17 shows a flow diagram of the logic of the chord detection system embodiment.

### DETAILED DESCRIPTION

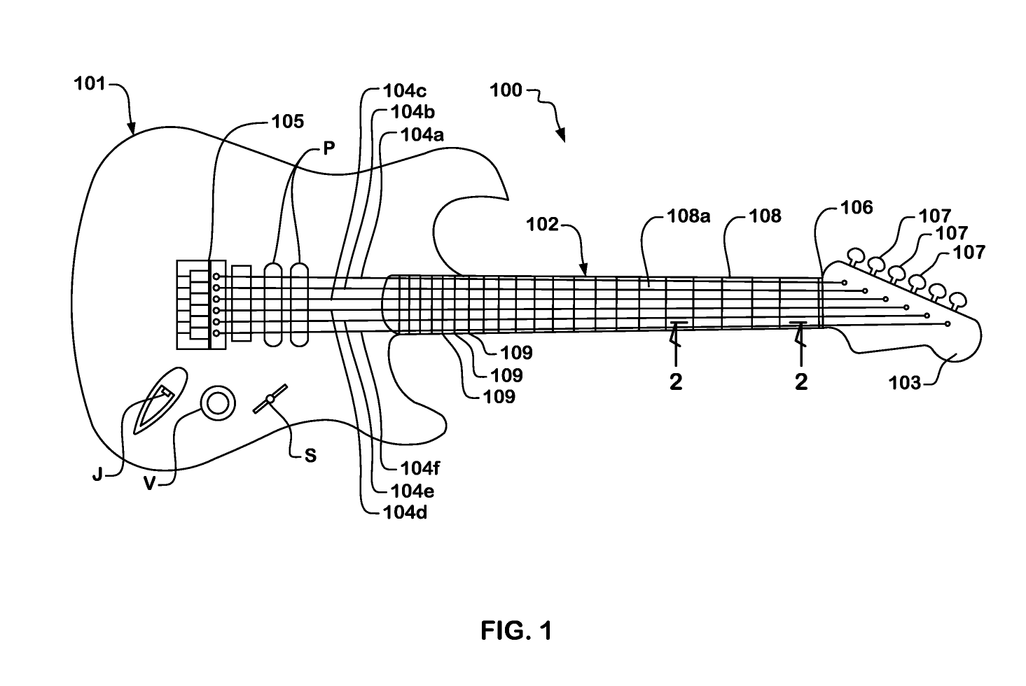

FIG. 1 shows a musical instrument generally designated 100. Instrument 100 is an electric guitar in the embodiment shown, but aspects of the disclosure are applicable to other stringed instruments as well. For example, guitar 100 could alternatively comprise an acoustic guitar, a cello, a violin, or the like.

Guitar 100 includes a body 101 and a neck 102. One end of the neck 102 is connected to the body portion 101 and an opposite end thereof has a headstock 103. In FIG. 1, six strings 104 a-f are shown strung between a bridge 105 and what is referred to as the nut 106 and an equal number of tuning pegs 107. As is well understood, strings 104 are secured to bridge 105 and on the opposite ends thereof to tuning pegs 107 wherein pegs 107 adjust the tension on strings 104 and hence the tuning thereof.

Guitar 100 also includes analog pickups P of the conventional magnetic type which could also be of the piezoelectric type as well. The latter being preferred for acoustic guitar and violin applications. Guitar 100 also includes a ¼ inch jack J, a volume control knob V and a pickup switch S.

Neck 102 further includes a finger board or fret board 108 having an exterior surface 108a and having a plurality of frets 109 extending therein and slightly above exterior surface 108a. Frets 109 visually indicate the desired half-note positions for each string. Strings 104 vibrate in their open position between bridge 105 and the nut 106 when picked, strummed, or the like. The musician typically uses their finger to press a string 104 against the fret board 108 at a desired fret position to produce a higher note.

In the embodiment shown, frets 109 located nearest the nut 106 are spaced further apart than the frets 109 located further down the fret board 108 towards bridge 105. As is well understood the physics of string vibratory harmonics is such that the distance between the nut 106 and, for example, first fret 105a is approximately 1.059 times longer than the distance between the first fret 105a and the second fret 105b. In general, the ratio of the spacing between successive frets is approximately 1.059:1 in order to correlate the frets with musical half-steps.

### Finger Contacting Sensing

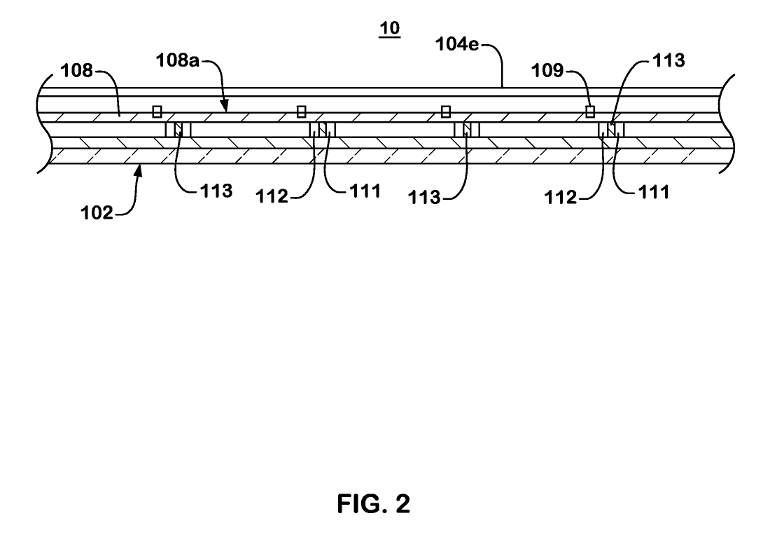

As more fully understood by also referring to FIG. 2, guitar 100 includes structure for determining at what point or points along fret board 108 a musicians finger or fingers, or other string pressing device such as a capo, are pressing one or more of the strings there against. Guitar 100 includes a sensor circuit board 110 positioned within neck 102 and below fret board 108. Circuit board 110 includes a plurality of surface mounted photo emitters 111 and corresponding photo sensors 112 and associated circuitry, not shown. Circuit board 110 may comprise a flexible circuit board in some embodiments. A photo opaque material 113 extends between emitters 111 and sensors 112.

Emitters 111 are generally oriented upward towards surface 108a and may comprise, for example, light emitting diodes (LED). Photo sensors 112 are also directed generally upward and detect reflected or diffused light. Sensors 112 can comprise phototransistors that produce a current proportional to the amount of light sensed thereby. In one embodiment there exists an emitter/sensor pair for each fret position of each string.

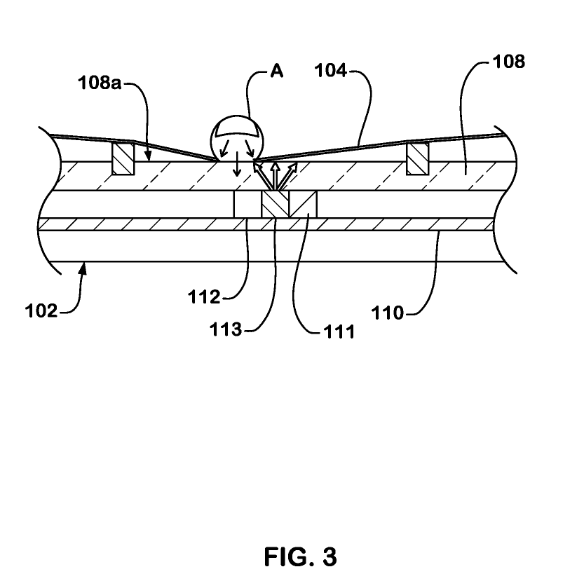

The basic operation of the finger pressing sensing capability of the present invention can be understood by also referring to FIG. 3, wherein it is seen that emitter 111 generates light in a generally upward direction through fret board 108 towards surface 108a. When a musician places their finger A against a string 104 adjacent a desired fret 109 and firmly against surface 108a of fret board 108, light from an emitter 111 is reflected off their finger A, and to a lesser extent string 104, to sensor 112. Sensor 112 generates a current corresponding to the level of detected light. This current can then be converted into a voltage which in turn is converted via an analog-to-digital converter for use in a microprocessor-based algorithm, as is discussed in greater detail herein below. Essentially then, when a desired threshold of light is detected, a finger pressing or contacting event is considered to have occurred and a stored frequency parameter is used to produce the desired note.

In a preferred embodiment, emitters 111 and sensors 112 operate using IR wavelengths. In experimenting with the suitability of sensors for use in detecting a fingertip it was found that while reflectivity from an approaching fingertip plays a role in deducing its location, the primary advantage of using IR comes from the fact that a human tissue absorbs light in the IR spectra wavelength whereby this light diffuses throughout the fingertip area.

An advantage of sensing IR light that is diffused throughout the fingertip is that the reading becomes greater in a favorable non-linear way as the fingertip approaches the maximum reading, which is when a fingertip is placed directly over the transmitter and receiver. This is not the case in a reflected visible light system as it depends entirely upon reflected light with no advantage from the additional light that diffuses through the fingertip and reaches the photo sensor. This fact has been verified by experimenting with different light frequencies that a human fingertip does not absorb, such as light from a blue LED. Using a blue LED and a phototransistor that is sensitive to the visible spectrum, it was found that a fingertip covering the transmitter and receiver has a much lower reading. Because precise fingertip detection is essential in a musical instrument such as a guitar, this method of reading light diffused throughout the fingertip is an important advantage.

In the case of IR based emitters and sensors fret board 108 is advantageously constructed of an IR-transparent material. The material may be opaque to visible light for aesthetic reasons. Fret board 108 will generally produce some amount of reflection which can be accommodated through calibration of the sensing system as is described in greater detail herein below.

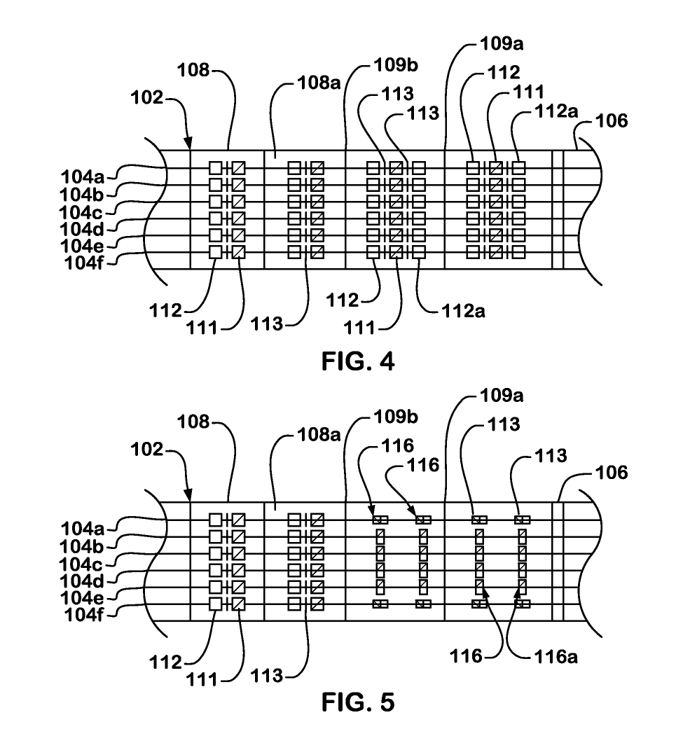

FIG. 4 shows a partial top-down plan view of fret board 108 showing an alternate arrangement of emitters 111 and sensors 112 there below. Specifically, between frets 109a and 109b and between fret 109a and nut 106 strings 104 a-f have two emitter/sensor pairs 116. Additionally, emitter pairs 116 for strings 104b-e are oriented in a manner rotated 90 degrees from the other emitter/sensor pairs 116 shown. This arrangement of additional emitter/sensor pairs in the larger fret areas permits a finger contacting event to be sensed over that larger area. With only one such sensing pair per string in, for example, the fret area between fret 109a and nut 106 and where that sensor pair is positioned adjacent fret 109a, finger contact in that fret area towards or adjacent nut 106 may not be sensed. The alternate positioning of the sensor pairs linearly beneath strings 104a and 104f, rotated 90 degrees from the orientation of the sensor pairs beneath strings 104b-e, is done to accommodate the fact that there exists less space on the outer edges of fret board 108.

As shown in the top plan view of the fret board 108 in FIG. 5 a further alternate arrangement of emitters 111 and sensors 112 is shown wherein additional sensors 112a are included between frets 109b and 109a and between fret 109a and nut 106. In stringed instruments, the distance between frets or between musical half-steps decreases according to a constant proportion. Although FIG. 5 is not to scale, the distance between the nut 106 and first fret 109a is greater than the distance between fret 109a and fret 109b. The use of an additional sensor 112a provides for an increased ability to sense a finger press or the like over the larger surface area defined by these larger fret areas.

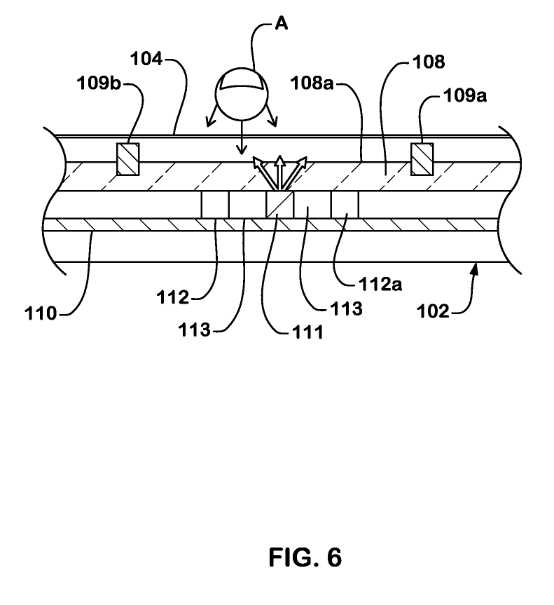

As further understood by also referring to the enlarged side cross-sectional view of FIG. 6, a finger A is shown approaching the surface 108a near a relatively large fret area, such as the area between the nut 106 and the first fret 109a. If a single transmitter 111 and receiver 112 were used, there may still be a signal produced by sensor 112 over the entire range of interest within the fret. However, the signal near the ends of the range may be much smaller than the one in an ideal position over the sensor pair. For example, if the sensor pair was located in the middle of the fret area, the voltage produced by sensor 112 would be greatest in the middle, but may taper off considerably at the extreme ends thereof. This signal reduction can be handled in the software by setting a lower threshold for a sensed current/voltage as determinative of a finger contact. However, if for example, that threshold is lowered so that whenever the voltage is above the voltage at the extremes, a valid fretted position is reported, that threshold may also be exceeded when a finger is in the air above the maximum sensor sensitivity position resulting in a false indication.

An additional receiver 112a can help to more accurately differentiate between an approach or press of the surface 108a by a finger A above and/or between frets 109a and 109b. By using the readings from both receivers 112 and 112a, a more accurate determination of the fingertip location can be produced. Thus, the control can see the output of both receivers 112 and 112a and have a means for in a sense triangulating the precise finger position. This improved accuracy is possible because the reading of both receivers 112 and 112a when the fingertip is in the air above receivers 112 and 112a and between frets 109a and 109b, for example, is different from the set produced when the fingertip is on fret board 108 between frets 109a and 109b. Moreover, the reading of both receivers 112 and 112a vary with respect to the position of the musician's fingertip along fret board 108 between frets 109a and 109b. Thus by looking at this two-dimensional data a control of the present invention can much more accurately determine the musician's precise finger placement. Thus, using such data it is possible, for example, to adjust the frequency of the sound played either sharp or flat as the musician's finger placement moves in either direction along the finger board away from the ideal point of contact for producing the desired string vibration frequency. Of course, in a fretted instrument such as a guitar the correct finger placement is identified by the frets so that movement away there from down the fret board results in a gradual and small lowering of string frequency. This change can then be detected and the precise tonal frequency played. Those of skill will understand that the software control can be set to require various accuracies of finger placement before indicating the playing of a note so as to either accommodate a novice player or challenge a skilled one. For a beginner then it can be possible to play the correct note regardless of the precise point of finger contact between frets 109a and 109b. On the other hand, various settings are also possible where it may be desirable as a training tool to only recognize a finger placement and generate a tone when the student player has made a precise finger placement. The latter can be particularly important for non-fretted stringed instruments such as a violin.

### Electronic Control

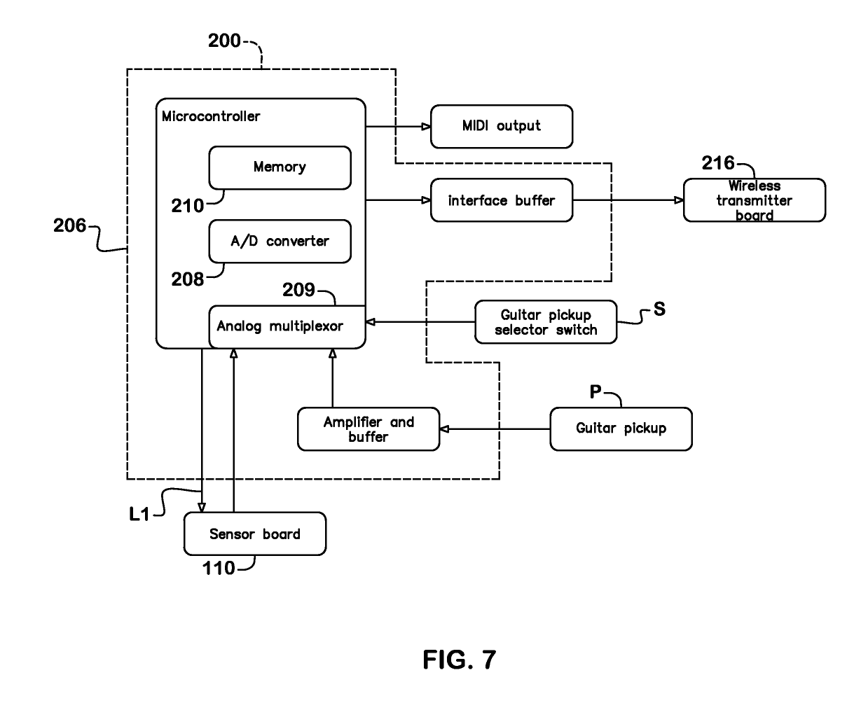

FIG. 7. shows a simplified block diagram of the electronics of the present invention wherein main board 200 includes a processor 206, an analog-to digital converter 208 and an analog multiplexer 209. Processor 206 may comprise a general purpose microprocessor, a microcontroller, an application specific logic device, or the like. Main board 200 can also include a storage device 210, such as a hard drive, flash memory, or the like. Storage device 210 may include a volatile memory, a non-volatile memory, or a combination of volatile and non-volatile memory devices. Sensor board 110 provides input data to processor 206 and receives output signals there from. Pickup P provides an analog signal to an amplifier/buffer 212 of control 200. Pickup up selector switch S is also connected to processor 206. An interface buffer 214 receives an output from processor 206 which can then be sent to a wireless transmitter board 216.

Main board 200 further includes a MIDI output module 216. For example, MIDI output module 216 may be connected to standard output jack J of guitar 100. Jack J may comprise a ¼-inch TS connector jack or in certain embodiments a ¼-inch stereo TRS connector jack or some other stereo connector. Other conductors may be utilized, for example, for an analog output signal from the guitar pickups and a ground. Processor 206 may also output digital signals indicative of the playing of the guitar via wireless transmitter board 217 connected via an interface buffer 218. Interface buffer 218 may simulate a dry contact closure with transmitter board 217. For example, processor 206 may output a MIDI signal to wireless transmitter 217 via interface buffer 218. Transmitter 217 is preferably a wireless transceiver. In other embodiments, the output module 116 comprises a ¼ inch TS connector input jack. Any other connector, such as a USB connector, may be used in other embodiments to communicate the MIDI data.

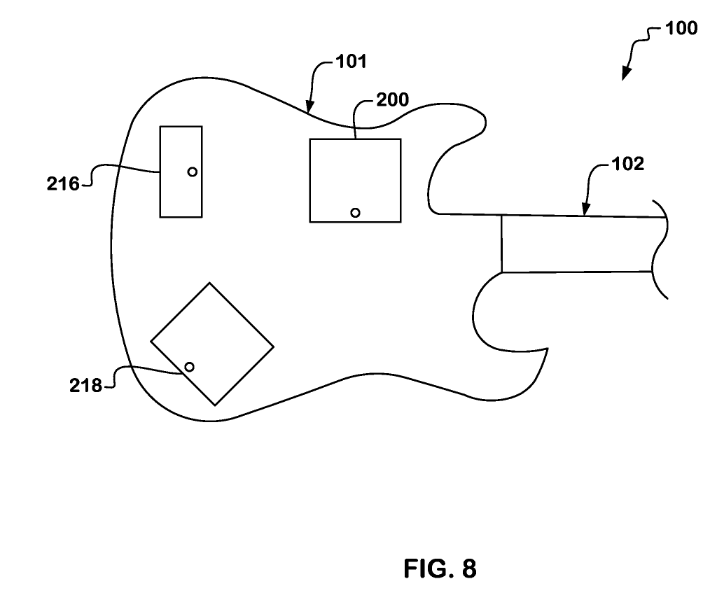

FIG. 8 shows a reverse plan view of the guitar of FIG. 1 wherein body 101 can include a plurality of cavities C having removable covers 219 a-c for retaining therein main control board 200, an electrical power source 220, and a wireless transmitter 217, respectively. Power source 220 provides power to the circuitry described herein. Power source 220 can consist of standard replacement battery cells, rechargeable cells or battery packs. Electrical power source 220 can also comprise an AC/DC converter connectable to a standard wall electrical outlet.

Main board 200 receives analog signals from sensor board 110 which may be passed through analog-to-digital converter 208 and multiplexer 209 and to processor 206. Processor 206 may be configured to determine, based on the received data finger locations, string or strings being played, volume levels, expression nuances being used, and the like; details of which will be described in greater detail herein below. In some embodiments the data or the information determined from the data may be stored in memory device 210. The stored data may be accessed at a later time by processor 206 for calibration purposes, for calculations requiring an analysis of positions over time, or the like as also described herein below in greater detail.

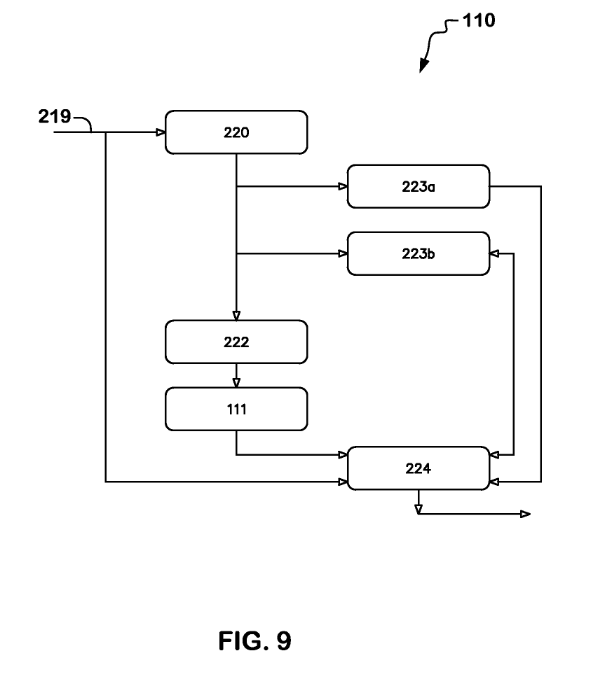

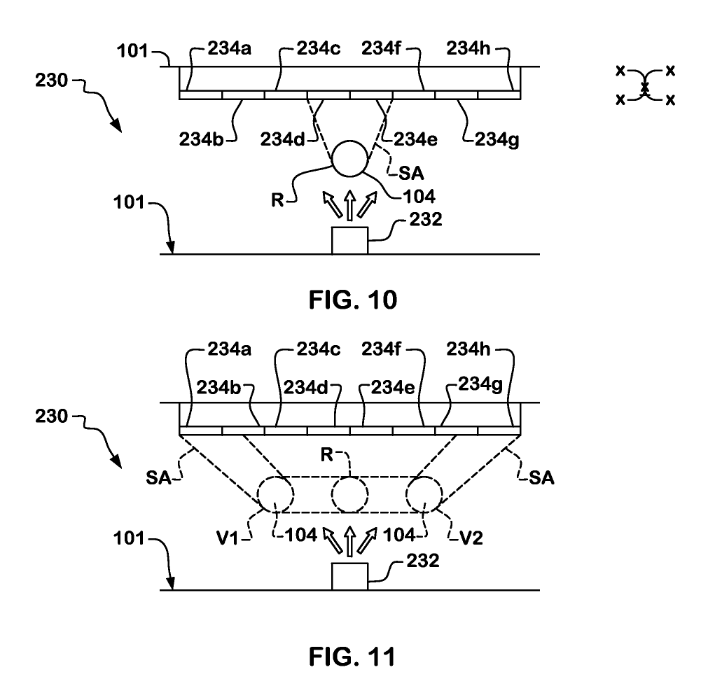

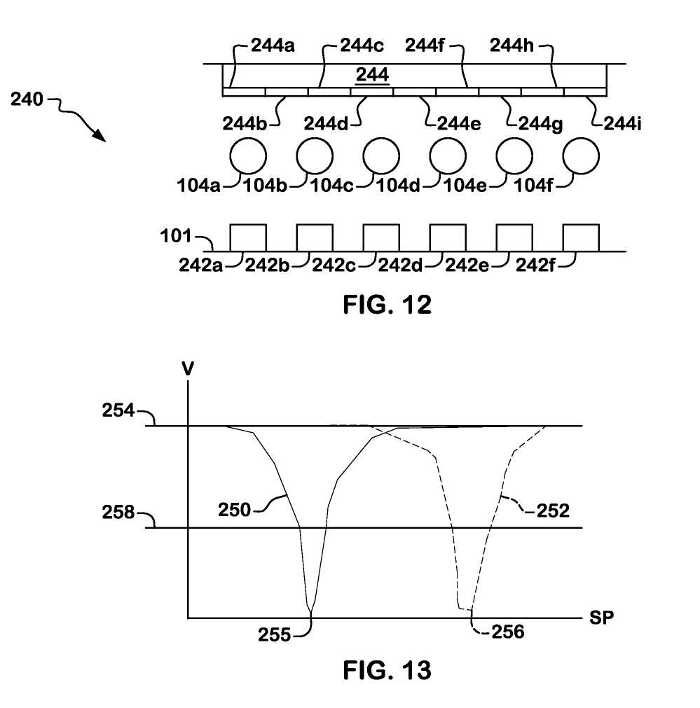

Sensor board 110 receives control signals along line L1 from processor 206 of main board 200. The control signals may comprise one or more of a data signal, a clock signal, or the like. As understood by also referring to the block diagram of sensor control board 110, seen in FIG. 9, these control signals are provided to a shift register 221. Shift register 221 may comprise one or more shift registers and may comprise a plurality of serial input/parallel output shift registers. In certain embodiments, multiple shift registers are chained together by connecting an output of a first register to the input of a second register.

The outputs of the shift registers 221 may be connected to one or more banks of photo sensors 223a and 223b and to a plurality of emitters 111 via a buffer 222. Buffer 222 provides an operating current to emitters 111. Shift registers 221 may be connected to photo sensor banks 223a and 223b and to emitters 111 via multiple wires or lines. For example, each output of shift registers 221 may correspond to a sensor module pair comprising an emitter 111 and one or more corresponding sensors 112.

Emitters 111 and photo sensor banks 223a and 223b are connected to a switch 224. Switch 224 is also connected by line L1 to the input control signal from processor 206. In the embodiment shown, the output of the switch 224 is controlled by the input control signals. Output control switch 224 may also control the activation of the emitters 111.

In operation, a clock signal and a data signal may be input to sensor board 110. The data signal may be input to a data input of the shift registers 221 and the clock signal may be input to a clock input thereof. Shift registers 221 may therefore output a high signal on one of the plurality of outputs thereof with the high signal being shifted sequentially through the outputs according to the clock signal. Thus, one of the plurality of outputs may be active at any given time.

The active output is connected to a collector of a photo sensor 112 in at least one of the banks 223a, 223b thereof. The corresponding emitter 111 of the photo sensors 112 are connected to switch 224, such that when a sensor 112 is exposed to light in its operating spectrum and the corresponding output of the shift register 221 is active, then a high signal will be provided to the switch 224. Each bank of sensors 223a and 223b may correspond to different photo sensors located proximate one another in certain embodiments. For example, an output of shift register 221 may be connected to a first photo sensor 112 in bank 223a and a second photo sensor 112a in bank 223b. Sensors 112 and 112a may correspond to a single fret position, as described previously, where by comparing the signals there from a more accurate determination of a finger location may be determined. The active output of shift register 221 may also be connected to one or more emitters 111 corresponding to the same fret position as just mentioned the photo sensors 112 and 112a.

Switch 224 may then control the activation of the emitters 111 and the output from banks 223a and 223b. For example, the signals from banks 223a and 223b may be output by the switch 224 according to a cycle determined by a data signal input to switch 224 from processor 206. Emitters 111 may be activated according to a different input such that they are connected to a voltage supply at certain times. For example, switch 224 may control a four phase cycle for each sensor module. In the first phase, a reading is output by switch 224 from the sensor bank 223a with an emitter 111 deactivated by switch 224. A reading is therefore output corresponding to a sensor module at a first position with the emitter 111 off. The data signal controlling emitters 111 through switch 224 may then be activated to turn on the corresponding emitter 111, and the signal from the same bank 223a may be output. This may provide a reading of a first sensor 112 with a corresponding sensor 112a. In the third phase, the clock signal may cycle causing switch 224 to output a signal from photo sensor bank 223b. The output may correspond to a reading from a second sensor 112a of the same finger location or sensor module with an emitter 111 on. In the fourth phase, an emitter 111 is turned off by switch 224 corresponding to the data control signal. The output remains the same such that the second photo sensor is read with the corresponding emitter 111 off. After the four phases have been read and a serial output provided, the process may repeat for the next output of the shift register 220. Thus, the process may cycle through each of the sensors 112, 112a and provide a serial output to the microcontroller 206 that corresponds to readings of each photo sensor 112 and 112a with the corresponding emitter 111 both on and off. The output signal may be de-multiplexed by the microcontroller 206 in order to generate a digital representation of which notes or positions are being played.

Components of the main board 200 are connected to various systems, inputs, and outputs of musical instrument 100. As seen in FIG. 7, certain components are shown on the main board 200 or as part of the processor board 206. In other embodiments, the components and modules seen in FIG.'S 7 and 9 may be combined into a single integrated circuit, comprise separate circuits, be located at locations other than the main board 200, or the like.

In some embodiments, certain components and modules may be added, replaced, or omitted. It is advantageous for cost reasons to minimize the number of wires that connect main board 200 to sensor board 110. Accordingly, sensor board 110 may use a serial interface to communicate there with. In some embodiments, a sensor 112 is therefore read as the associated transmitter 111 is strobed on. The transmitters 111 may be strobed one at a time, for example at a frequency of approximately 8 MHz. When there is an array of both transmitters 111 and receivers 112, it is advantageous to multiplex the operation of reading the array.

Those of skill will realize that there exists a wide range of emitters 111 and sensors 112 available from which to choose depending upon the particular constraints/requirements of the type of instrument for which finger contact sensing is being provided and with respect to other cost and performance criteria. Those of skill will understand that these sensors are sized to permit a separation of approximately 5 millimeters. In other embodiments sensors 112 and transmitters 111 may be separated by some other distance. The barrier 113 may be located between transmitter 111 and receiver 112 in order to substantially prevent leakage and false reflections of light. It was found that the invention herein can allow for very accurate, reliable, and repeatable detection of a finger or object in order to determine a note to be played. For example, the sensor modules described can detect the presence of a finger or object within approximately one inch or more of the playing surface, and can accurately determine the distance of the finger or object to within approximately 0.1 inches or less. The accuracy of the system, coupled with distinct playing areas on a firm playing surface in some embodiments, allows for the repeated and accurate activation of particular notes. This accuracy and repeatability is advantageous in replicating the playing of a standard guitar, which has many distinct note locations.

### Expression Capture

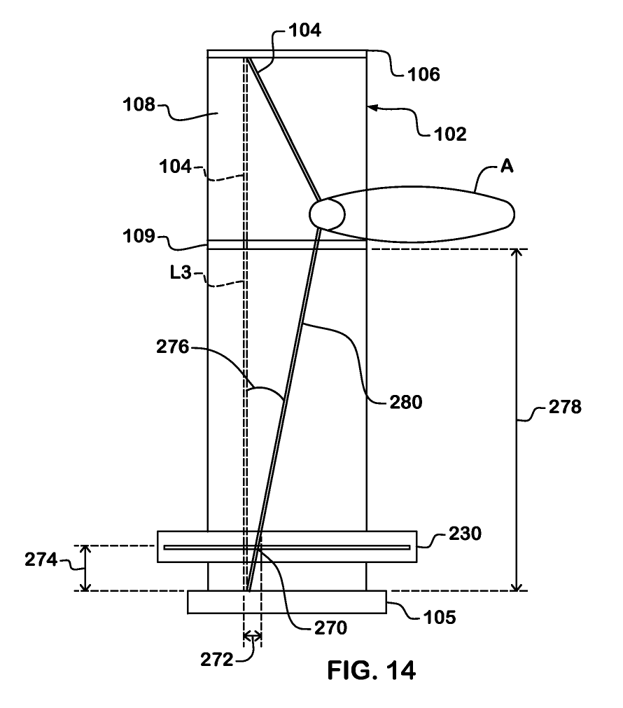

String bending is generally a technique where a musician, as he or she is pressing down on a string, moves it laterally or essentially ninety degrees to its direction of extension. This movement causes stretching of the string and therefore changes the pitch of the note it would normally produce at the particular non-deflected normal fret position. FIG. 14 illustrates a novel method of detecting string bending using detection system 230. The string bending method described here may be used as an alternative or in addition to the methods described with respect to sensor 230.

A string 104 is shown held in place at one end by nut 106 and at the other end by the bridge 105. A fret 109 is shown, and a finger A is shown depressing and bending the string 104 at the fret 109. A dashed line L3 is shown representing the resting position of string 104. The string 104 runs generally in a first direction along the neck 102 when in a resting position. The resting position of a string 104 as it intersects sensor system 230 is known based on calibrated values. When a string 104 is bent by finger A, or some other object, string 104 intersects sensor system at a new point 270. The new location 270 is offset in the second direction by an offset amount 272. It will be appreciated that the amount of bending of string 104 as shown in FIG. 14 is not to scale and exaggerated to more clearly explain bend detection according to the embodiments herein. In various embodiments, string bending may comprise any amount of bending of the string 104, whether by pushing or pulling the string.

The calculated offset distance 272 is utilized with a known distance 274 in order to calculate an angle 276. Known distance 274 comprises the distance from the point where the vibration of the string 104 is substantially anchored at bridge 105 to the point where string 104 crosses sensor system 230. The distance 278 from bridge 105 to fret 109 is known when the fret position pressed by the finger A as determined by the finger contacting system described herein above. A new relative string length in the stretched position as indicated by number 280 and is essentially equivalent to the distance between the contact point of finger A and bridge 105. This distance is calculated by using angle 276 and length 278. A frequency corresponding to the new string length 280 is determined and a signal output corresponding to that frequency or an output signal may be modified to indicate the presence and/or the magnitude of bending. In other embodiments, a table may exist in memory 210 that directly correlates the offset of the center of vibration, in terms of the number of photosensitive elements 244a-f, from the resting location with a value indicative of an amount of bend or an amount to modify a note.

Since this method does not require frequency analysis, very detailed and high-speed readings can be taken and used to influence the pitch of the note appropriately. The inherent analysis time of frequency methods precludes rapid string-bend measurements, and is subject to “tracking errors” since the frequency of a bent string rapidly changes. The method described advantageously eliminates this as an issue and results in an accurate reading of string bending across all strings according to some embodiments.

Another method for detecting string offset or plucking is an analog method that performs an analog-to-digital conversion and analyzes the data produced when a string is plucked. While the signal used, which may be the signals generated by standard electric guitar pickups or the like, is similar to signals used in methods currently employed, the task of determining when to initiate a note is simplified since frequency analysis is not required. For example, when starting from a string at rest, the fact that a signal becomes present is enough to indicate that a string has been plucked and a note code can be sent out. Thus, according to some embodiments, this method may be able to detect a string that has been picked without waiting for the string vibrations to subside to a rest position state. In a prototype guitar, it was observed that the waveform produced through various methods of picking the string produce characteristic signals that can be detected by a microcontroller algorithm. For example, if a string has been plucked and, before it comes to rest, is plucked again, for a short period of time the string will cease vibration and then resume with the new pick. This interruption of vibration may be about 10 milliseconds. This gap can be measured and taken into account when deciding when a new pick event has occurred.

According to some embodiments, the processor analyzes the incoming waveform in discrete slices of time and implements a state machine to deduce the string state. A rest position is easily detected, after which a positive or negative voltage increase is taken to mean a string that was picked. In some embodiments the processor detects an excursion of the waveform in one direction, followed by an excursion in another direction within an appropriate amount of time in order to prevent false readings, for example from tapping the body of the guitar. Further analysis may be done in discrete time segments after this initial event to decide when a note should be ended, or when a string was re-picked.

Vibrato on a conventional guitar, for example, can be produced by rapidly moving the fingertip up and down. This subtly changes the frequency of vibration of a string. As discussed, existing MIDI guitars that employ frequency analysis techniques do not work well for capturing vibrato, since the time taken for the analysis makes the granularity of the vibrato reading too large to be effective. Using the sensors described, however, extremely fast readings can be taken so that effective vibrato can be accurately captured.

Assuming a guitar 100 that has emitter 11/sensor 112 pairs populating the fret positions of multiple strings 104, string bending can also be captured. This can be done by taking into account the readings of the sensors 112 that are in the same fret position but on adjacent strings 104. For example, moving a first string 104a towards second string 104b will cause a gradual decrease in the reading from string 104a sensor/emitter pair and a concomitant with a gradual increase in the reading of the sensor/emitter pair of string 104b adjacent thereto and on the same fret. This data can also be used to provide accurate string bend information.

“Hammer-ons” and “pull-offs” are easily read with the sensor method since a history of the notes fretted is easily maintained. These expressions can be difficult to capture in analog-to-digital systems because very little in the way of note volume is produced with these expressions, and the volume may be below the threshold of being registered.

In addition to these traditional forms of expression, new and novel forms of expression that have not been possible in a stringed instrument such as a guitar can be produced using the sensor system. For example, “aftertouch” is a common MIDI expression parameter used in electronic musical keyboards. This consists of modulating some parameter of the sound after the key is pressed by continuing to apply pressure down on the key after the initial note is played. With the sensor system described here, it has been found that increasing pressure from the fingertip results in a significant voltage increase that the sensors report. This can be used for aftertouch.

A novel expression capture technique can utilize the readings of a fingertip rising off the fret board after the initiation of the note. This could be done for a limited amount of time and/or distance to influence the sound of the note. The sensors can be set to influence different note positions in different ways, and may be sensitive to small changes in position that do not require the fingertip to stray far from the playing surface so that rapid sequences of notes can be played.

### Calibration

There are multiple types of calibration that may be used by guitar 100. The guitar 100 may utilize active calibration using current sensor information, stored calibration using stored data, some combination of current and stored date, or the like.

Active calibration may be an ongoing activity that analyzes, for example, ambient light and legitimate fingertip placement readings. This may become part of an adaptive algorithm that improves the ability to distinguish between false positives and legitimate positions.

Ambient light detection and compensation may take into account the readings of one or more of the sensor module pairs 111/112. As described above, a receiver 112 creates a voltage proportional to the light it receives, which may be assumed to be the light emitted by the associated transmitter 111 and diffused through the fingertip. However, in settings where there is a high amount of ambient light, a voltage may also be produced by a receiver 112 without a finger press and could be confused with a valid fingertip reading.

In this case of high ambient light, placing a fingertip over the sensor may actually block the ambient light. This is because the fingertip diffusion method discussed above may not be as effective unless the source of emitted light is in close proximity to the fingertip. Room lighting, for example, will not appreciably penetrate the fingertip and is blocked with the fingertip over the sensor.

To distinguish between ambient light and diffused light from the fingertip, transmitters 111 can be strobed and two readings taken. Initially, with transmitter 111 off, corresponding receiver 112 is read. Any voltage at that point is known to be caused by ambient light. In one embodiment, if there is a minimal voltage of a sensor 112 when the corresponding transmitter 111 is off, then there is a relatively low level of ambient light. In this case, microprocessor 206 may be configured to use a standard fingertip detection method, such as the methods described above or a variation thereof.

If there is a moderate to high voltage output of sensors 112 when its corresponding transmitter 112 is off, then there may be a relatively high level of ambient light. In this case a fingertip in a valid position may block the ambient light, resulting in a reduced reading. In one embodiment, processor 206 may be configured such that when instrument 100 is determined to be in a high ambient light environment, a finger press will be recognized when the reading drops below a predetermined threshold voltage. In some embodiments, the finger press may then be validated. The finger press may be validated by strobing transmitters 111 on while reading the response by the corresponding sensors 112. If a finger is present and blocking the ambient light, then it should also diffuse some of the light emitted by a transmitter 111. In the case that the voltage produced by a sensor increases above the normal or low ambient light threshold, then the finger may be in a valid position. When the reading by receiver 112 does not increase above the normal threshold, then it may be determined that there has not been a finger press.

When an array of sensor 112/emitter 111 pairs are used on the fret board 108, the readings from the other sensor/emitter pairs can also be taken into consideration. Since it can be assumed that the musician's fingertips can not cover all of the sensor/emitter pairs, correlating the current sensor information with that of others can help to refine the decision about fingertip placement in high ambient-light areas.

Active calibration may also react to changing conditions such as battery voltage changes, changes in the condition of the surface 108a, or the like. Readings taken with a transmitter 111 on and without a fingertip near the fret board can be compared to the initial stored calibration values to determine if, for example, the voltage has changed, the surface 108a is scratched or dirty, or the like. This ongoing calibration can be done initially at power up. An instruction may be given to the user to make sure no fingertips are near the fret board 108 in some embodiments. In this way, changes such as surface scratching can be taken into account in the algorithm.

Stored calibration processes may be used to account for manufacturing tolerances in some embodiments. In addition, it can be used to account for variations in individual players or playing styles. Initial stored calibration may be done at the factory, but a provision can be made for players to tailor the calibration to their own needs in some embodiments.

A stored calibration process may scan the sensor/emitter pairs and create a table of baseline values. It is assumed during this process that no fingertips are present, so the values read from each sensor when the photosensors 112 are activated represent the reflection that is present in the assembly. These values may be stored in a table inside microprocessor memory 210 where memory 210 is non-volatile. A fingertip detection algorithm, such as certain methods discussed above, may examine the difference between the baseline reading and a current reading when making the determination about whether a fingertip is present.

Another form of stored calibration may be used for tailoring the sensors to the fingertips or style of playing of the user. For example, a beginner might choose to calibrate the system in such a way that just resting a finger lightly on the string above the desired fret will register a fretted position, while an advance player may wish to require full pressure on the string against the fret.

In some embodiments, this form of calibration may be activated at any time by the user. For example, it may be activated through a specific sequence of button-presses upon power-up. The player may then place the fingertips in a valid position, and the readings may be recorded and stored in memory for later comparison. In some embodiments, the user may run his or her fingertip down the string across the valid fret positions. A series of values may then be stored for later comparison. In another embodiment, a single fret or position can be selected and an “entry” switch activated to store the value for that single fret or position. An entry could be made by plucking a string or by pressing a switch.

To refine the decision about legitimate fingertip placement, the history of “note confirmation” can be taken into account. In the case of a guitar 100, this confirmation takes place when a string is plucked. If, during the course of play, a false note error occurs, means may be provided for the user to indicate this, so that the error condition can be avoided in the future. In addition, multiple readings can be stored as the fingertip approaches the sensors in order to aid calibration. This may create a short-term history of the fingertip position as it approaches the sensor. When the fingertip contacts the surface, there may be a distinct change in the received readings that can be used to detect a finger press without use of an ‘entry’ switch or the like. For example, an increasing voltage level over a period of time may be determined to be a fingertip approaching the fret by the microcontroller. In some embodiments, this voltage may reach a maximum value when the fingertip contacts the surface.

### Note Pattern Recognition

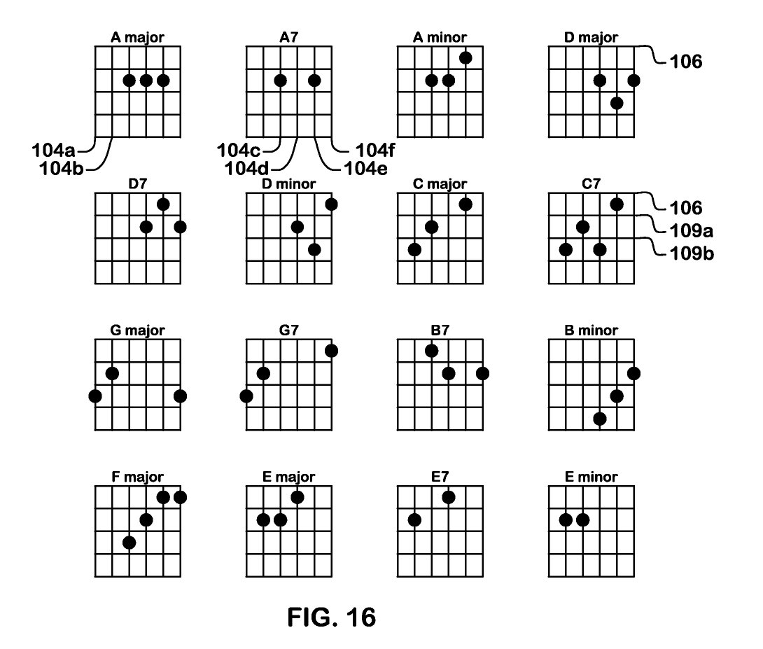

Those of skill will understand that an instrument having a finger pressing sensing capability as described herein can play several notes simultaneously and that combination of tones will be reproduced. As is well understood playing a chord is comprised of playing several notes at once. A schematic representation of several basic guitar chords is seen in FIG. 16. Those of skill will immediately understand that the black dots correspond to the finger fret contact positions for the identified chords wherein the top horizontal line represents nut 106 and the further horizontal lines represent the subsequent frets 109, such as frets 109a and 109b as indicated and where the vertical lines represent strings 104 a-f. Such chords will automatically be played directly as a result of the ability of the invention herein to recognize a plurality of finger press positions and play the appropriate notes. However, memory 210 can store the finger press patterns of each of the represented chords, and any number of other chord patterns, so that when finger presses are seen in the appropriate positions that chord can be played. This chord recognition ability provides some additional benefits. Those of skill understand that when playing some of the indicated chords, e.g. E major, E minor and G major, all of the strings not being contacted are then strummed in their open position. However, with other chords, e.g. C7, B major and B minor, one or two of the lower strings, i.e. the E and the A, and as they have been indicated herein 104a and 104b respectively, are not desirably strummed. This can be difficult for a beginning student and the software herein has the capability to recognize the chord that is intended to be played and then play only the proper notes even if certain of the strings that are not supposed to be played have nevertheless been strummed.

Additionally, a switch such as S can be used to activate this chord training mode which then also activates the additional sensor pairs that may exist in the lower note larger fret areas so that finger placements at more positions therein will be recognized. In this manner there exists more “forgiveness” in the chord pattern recognition as virtually any recognizable finger placement in a larger fret area will count in determining the playing of a particular note of a recognized chord pattern.

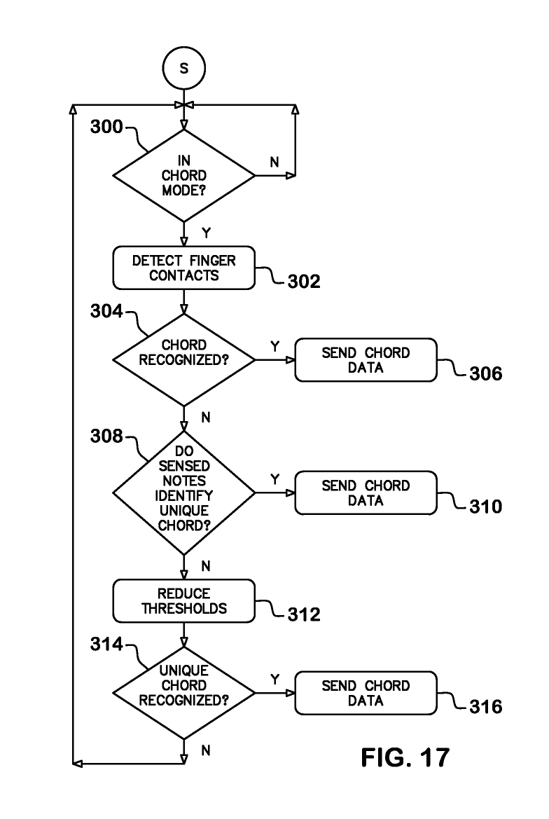

Those of skill will also understand that the invention herein has the capability to recognize a chord pattern and play that chord even if not all the finger placements for that chord are initially recognized. A better understanding of this ability to “fill in” a missing note can be had by referring to the software decisional flow diagram of FIG. 17. At decision block 300 it is determined what mode has been activated, such as a “chord mode” or “beginner mode”. If so, then at block 302 finger contacts are detected. If at decision block 304 all the proper finger contact points are detected for a unique chord, then at block 306 proper MIDI frequency data for that chord are sent along with the volume data as determined by, for example, pickup P or sensor 230. If all the notes for a particular chord are not sensed, then at decision block 308 it is determined if the contact points sensed nevertheless comprise a unique chord out of those stored in memory. If so, then at block 310 all that chord data is sent as at block 306 whereby any “missing” notes are supplied. If no unique chord has yet been determined, then at block 312 the thresholds are reduced for the sensor pairs in the fret areas which contain the contact points for the chords in memory. If a unique chord can now be recognized at block 314 then the appropriate MIDI data is generated at block 316. If no unique chord can be determined at this point then the process can recycle through the above sequence. As described above, the output of instrument 100 can be sent to a video game or teaching system wherein, for example, the name of the chord can be displayed along with a schematic as per FIG. 16 showing or verifying that the proper finger contact positions have been made. Where a chord is not identified, that can be shown on the video display by a phrase indicating no chord detected.

### Game Controller

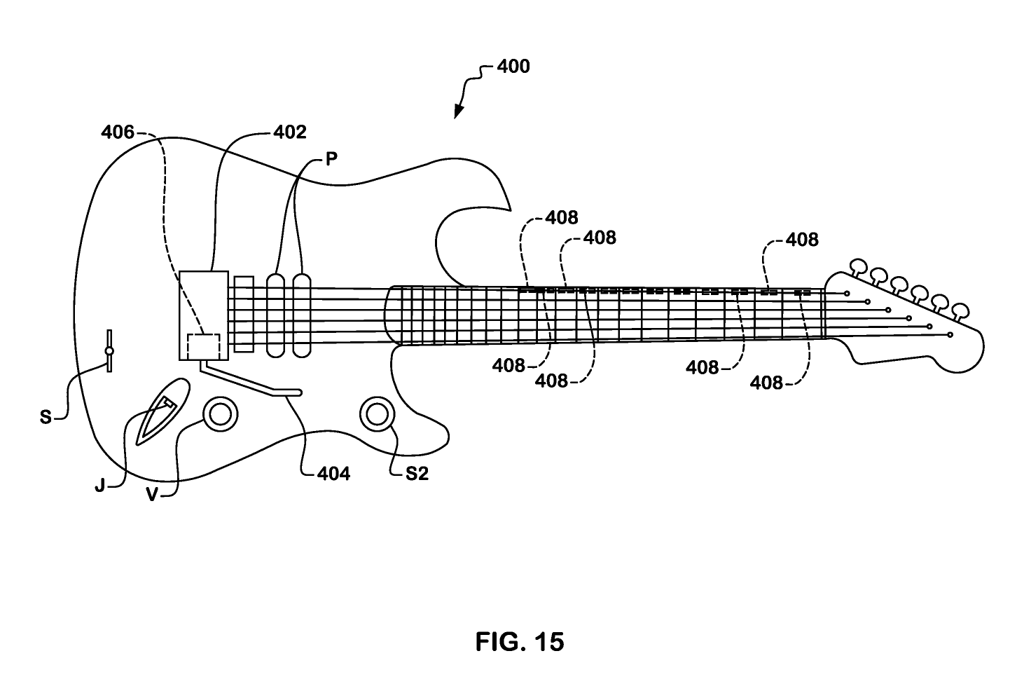

A further guitar embodiment is seen in FIG. 15 and identified by the numeral 400. Guitar 400 is the same in most respects as guitar 100 as previously described and as seen in FIG. 1. However, guitar 400 also includes a simulated tremolo bar device 402 as used in guitar shaped game controllers used with the “Guitar Hero®” and “Rock Band®” video games. Simulated tremolo bar device 402 differs from an actual tremolo bar in that it is not physically connected to the bridge of a guitar for the purpose of stretching all of the strings simultaneously and increasing the pitch thereof. Rather, as is known in the art, tremolo bar device 402 includes a tremolo arm 404 having a pivotal spring loaded connection to a potentiometer 406. Guitar 400 also includes a multi-position blade switch and can also include one or more additional multi-position blade or rotational switches S2. In the embodiment of guitar 400 finger placement sensors 408 are located beneath the low E string in the top 12 fret areas thereof. Sensors 408 can be, for example, as previously described herein in FIG. 6 and each include; an emitter 111 and receivers 112 and 112a.

Guitar 400 can be used as a wireless or wired game controller wherein wireless transmitter 216 of control 200 can be used to broadcast a MIDI signal to an external computer. Thus, signals generated by switches S and S2, tremolo bar 402 and position sensors 408 can be used by control 200 to generate signals by microcontroller 206 to be broadcast to an external video game system by the transmitter 217. The digital codes may correspond to a wireless interface and control scheme utilized by a gaming or other computer system. In other embodiments, a wired connection may be utilized to provide the digital codes or signals to a gaming system. For example, a wired connection might be achieved utilizing standard guitar jack J. If jack J comprises a ¼ inch stereo TRS connector, one signal line can be dedicated to the digital codes or signals.

Sound effects producing equipment is well known in the art and includes software driven hardware devices that can be programmed to produce any of a wide range of sound effects. Such equipment usually works as an interface to alter the sounds produced by an amplifier loudspeaker system. Thus the analog inputs from guitar pickups are changed to produce different sound effects. Such equipment can include input devices such as a mouse, touch screen or various switches to select between the desired sound effects. Since these are not generally convenient for the musician to operate during a performance, tremolo bar 402 and/or switches S and S2 and/or photo sensors 408 can be used such input devices. As per the description relative to a video controller, tremolo bar 402 and/or switches S and S2 and/or photo sensors 408 can be used to produce signals that can be sent wirelessly or by wire to the sound effects equipment.

It will be appreciated that guitar 400 is a normal electric guitar to which is added wireless game controller components, well known in the art, as well as the touch recognition sensor systems as described herein. The game controller components have the advantage of being very low cost as they are in mass production, but other wireless technology can be used. The wireless components are connected to switches S, S2, the potentiometer 406 of tremolo bar 402 and the touch recognition sensors. Switches S and S2 and tremolo bar 402 are located on the face of guitar 400 so that they can be easily manipulated by a musician during a performance. Sensors 408 are also convenient to the musician as they are contained within fret areas played by him or her.

The wireless components of guitar 400 will transmit to a receiver, typically a personal computer or game console. Thus, selector S may comprise, for example, a three- or five-position blade switch where three of the positions are used to switch between either or both of the pickups P and where one of the additional two remaining positions may be connected to microcontroller 206 in order to activate certain wireless codes, for example for use with a video game. Switch S can also be used to switch guitar 400 between a game playing mode and a regular guitar playing mode.

A pickup selector switch such as switch S in a traditional electric guitar is used to route various combinations of the magnetic guitar pickups P to the output of the guitar. The invention herein can, as mentioned above, adapt such a switch S to transmit signals to software to affect sound and or playing mode. Those of skill will appreciate that an added benefit of this approach is that the various sounds of different combinations of pickups can determined by different positions thereof such that only a single guitar pickup P need be used in the construction of Guitar 400. In this manner the cost of manufacturing an electric guitar can be reduced.

A further switch or switches S2 can be used to provide the guitarist with further combinations and permutations of switch positions with which to signal and change external sound effect software to obtain easy and quick access to a greater range of sound effects. If, for example, switch S2 had five positions then each such position could provide for a different effect in combination with each of the twelve touch position sensors 408. In this manner a potential of sixty different settings could be easily and quickly accessed.

Those of skill will understand that either of switches S or S2, for example, could signal a “touch only” mode where in the example of guitar 100 the entire fret board 102 can be populated with photo touch sensors, wherein playing of notes at a predetermined volume occurs by touching fingers to the fret board without the necessity of strumming the strings. In this mode, tremolo arm 406 could be manipulated to provide the same sound effect input of a potentiometer based foot pedal.

Tremolo bar 402 can also be used as a further switch permitting the user in a video game mode to select among various parameters as required by the video game, including number of players, song selection and level of difficulty. In a guitar mode simulated tremolo bar 402 can also be used to switch between a plurality of sound effects thus also permitting an additional way for easy access to a wider range of sound effects as is currently common for musicians playing a keyboard. Those of skill will understand that Guitar 400 can be used as a traditional electric guitar producing analog output from pickups P. The simulated tremolo bar 402 and/or the switches S and S2, and/or the photo sensors 408 can, as mentioned above, be used for the purpose of operating either wirelessly or by wired connection as input devices for operating the sound effect software and hardware connected to an amplifier and loud speaker system. Thus, a musician is afforded an easy way to change the settings available to them on the sound effect software and hardware equipment while they are performing through use of familiar and convenient switches S, and S2 and tremolo bar 402. If photo sensors 408 are additionally included, those of skill will appreciate that they can also be used as input devices and provide a convenient means for the guitarist to control such sound effect equipment.

In some embodiments, a paddle or other simple two or one position switch may be utilized on guitar 400 to mimic the strumming of all the strings or plucking of a specific string and to generate a signal indicative of playing a note or chord.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A system for providing an electronic output from a stringed musical instrument having one or more strings held in tension over and along a fingerboard where the one or more strings can be played by pressing of one or more thereof into contact against the finger board while causing the one or more strings to vibrate and produce a sound, comprising:
a contact sensing system for sensing the pressing of a string against the finger board, the contact sensing system having a plurality of sensor pairs below and along the finger board for each of the one or more strings, the sensor pairs including at least one photo emitter and at least one corresponding photo sensor, the photo sensor for producing a signal relative to light received thereby,
a string movement sensing system,
an electronic control connected to the string movement sensing system and to the contact sensing system wherein the electronic control determines one or more points of contact of the one or more strings with the fingerboard as a function of the signal produced by the photo sensors there below, the position of a sensor pair on the finger board being indicative of a particular frequency produced by each of the one or more strings as a result of contact thereof with the finger board there above whereby the electronic control produces frequency data for each sensed point of contact, and the electronic control producing volume data for each one or more string if movement thereof is sensed by the string movement sensing system.

2. The system as defined in claim 1 and the photo sensors being IR photo sensors.

3. The system as defined in claim 1 and having a plurality of sensor pairs wherein more than one emitter and receiver pair will signal the production of the same frequency for the same string.

4. The system as defined in claim 1 wherein one or more of the sensor pairs each comprise two emitters and one receiver.

5. The system as defined in claim 1 and the control having a memory for storing finger board string contact points corresponding to finger board contact points of one or more musical chords wherein the electronic control produces frequency data for all the stored contact points of a particular chord if the sensed finger board contact points correspond to the stored finger board contact points.

6. The system as defined in claim 1 and the control having a memory for storing finger board string contact points corresponding to finger board contact points of one or more musical chords wherein the electronic control produces frequency data for all the stored contact points of a particular chord if the sensed finger board contact points correspond to less than all the stored finger board contact points for the particular chord.

7. The system as defined in claim 1 and the control having a memory for storing finger board string contact points corresponding to finger board contact points of one or more musical chords wherein the electronic control produces frequency data for all the stored contact points of a particular chord if the sensed contact points are less than all of the stored contact points for the chord and if a unique musical chord can be determined by the control from the plurality of sensed contact points.

8. A stringed electronic musical instrument, comprising:
a finger board having one or more strings held in tension over and there along where the one or more strings can be played by pressing of one or more thereof into contact against the finger board while causing the one or more strings to vibrate and produce a sound,
a contact sensing system for sensing the pressing of a string against the finger board, the contact sensing system having a plurality of sensor pairs below and along the finger board for each of the one or more strings, the sensor pairs including at least one photo emitter and at least one corresponding photo sensor, the photo sensor for producing a signal relative to light received thereby,
a string movement sensing system,
an electronic control connected to the string movement sensing system and to the contact sensing system wherein the electronic control determines one or more points of contact of the one or more strings with the fingerboard as a function of the signal produced by the photo sensors there below, the position of a sensor pair on the finger board being indicative of a particular frequency produced by each of the one or more strings as a result of contact thereof with the finger board there above whereby the electronic control produces frequency data for each sensed point of contact, and the electronic control producing volume data for each one or more string if movement thereof is sensed by the string movement sensing system.

9. The system as defined in claim 8 and the photo sensors being IR photo sensors.

10. The system as defined in claim 8 and having a plurality of sensor pairs wherein more than one emitter and receiver pair will signal the production of the same frequency for the same string.

11. The system as defined in claim 8 wherein one or more of the sensor pairs comprise two emitters and one receiver.

12. The system as defined in claim 8 and the control having a memory for storing finger board string contact points corresponding to finger board contact points of one or more musical chords wherein the electronic control produces frequency data for all the stored contact points of a particular chord if the sensed finger board contact points correspond to the stored finger board contact points.

13. The system as defined in claim 8 and the control having a memory for storing finger board string contact points corresponding to finger board contact points of one or more musical chords wherein the electronic control produces frequency data for all the stored contact points of a particular chord if the sensed finger board contact points correspond to less than all the stored finger board contact points for the particular chord.

14. The system as defined in claim 8 and the control having a memory for storing finger board string contact points corresponding to finger board contact points of one or more musical chords wherein the electronic control produces frequency data for all the stored contact points of a particular chord if the sensed contact points are less than all of the stored contact points for the chord and if a unique musical chord can be determined by the control from the plurality of sensed contact points.

15. The instrument as defined in claim 8 and further including a wireless transmitting system connected to the control for sending signals to a game control console as a function of the signals generated by one or more of the predefined sensors for affecting game play as required by a music based video game.
The system as defined in claim 1 and the control system having a memory for storing finger board string contact points corresponding to contact points of one or more chords wherein the electronic control produces frequency data for a particular chord if the stored finger board string contact points correspond to the sensed finger board contact points.

16. The instrument as defined in claim 8 and comprising an electric guitar, and the guitar having a body having a neck extending there from and having the finger board extending along on an outer surface thereof over which the one or more strings are strung and held in tension there over,
the body having one or more pickups for producing electrical signals produced by the vibration of the one or more strings, the signals sent to an amplifier for producing sounds based on such signals.

17. A stringed electronic musical instrument, comprising:
a finger board having one or more strings held in tension over and there along where the one or more strings can be played by pressing of one or more thereof into contact against the finger board while causing the one or more strings to vibrate and produce a sound,
a contact sensing system for sensing the pressing of a string against the finger board at a certain point there along,
an electronic control connected to the string movement sensing system and to the contact sensing system wherein the electronic control determines one or more points of contact of the one or more strings with the fingerboard as a function of the signal produced by the contact sensing system, the position of contact along the finger board being indicative of a particular frequency produced by each of the one or more strings as a result of contact thereof with the finger board whereby the electronic control produces frequency data for each sensed point of contact.

18. The system as defined in claim 17 and the control having a memory for storing finger board string contact points corresponding to finger board contact points of one or more musical chords wherein the electronic control produces frequency data for all the stored contact points of a particular chord if the sensed finger board contact points correspond to the stored finger board contact points.

19. The system as defined in claim 17 and the control having a memory for storing finger board string contact points corresponding to finger board contact points of one or more musical chords wherein the electronic control produces frequency data for all the stored contact points of a particular chord if the sensed finger board contact points correspond to less than all the stored finger board contact points for the particular chord.

20. The system as defined in claim 17 and the control having a memory for storing finger board string contact points corresponding to finger board contact points of one or more musical chords wherein the electronic control produces frequency data for all the stored contact points of a particular chord if the sensed contact points are less than all of the stored contact points for the chord and if a unique musical chord can be determined by the control from the plurality of sensed contact points.
